(19) United States
(12) Patent Application Publication
(10) Pub. No.: US 2005/0270260 A1
(43) Pub. Date: Dec. 8, 2005

(54) Active display

(75) Inventors: Heiko Pelzer, Erkelenz (DE); Achim Hilgers, Alsdorf (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/527,773

(22) PCT Filed: Sep. 5, 2003
(86) PCT No.: PCT/IB03/03886

§ 371 Date: Mar. 14, 2005

(30) Foreign Application Priority Data
Sep. 17, 2002 (DE) 102 42 978.2

(51) Int. Cl. G02B 27/02

(52) U.S. Cl. 345/82; 359/442

(57) ABSTRACT

The invention relates to a projection system comprising an active display (1, 1′). The display comprises radiation-sensitive control units (4) which decode the information about brightness and color of a pixel in the signal beam (1) of a projector (2) and drive connected light-emitting diodes (3) accordingly. Due to the self-sufficient mode of operation of these pixels, it is possible to build up comparatively flat and large-sized projection faces whose brightness is not limited by the capacity of the projector (2).

The invention relates to a display having a display face with active pixels. The invention also relates to a projection device and to a method of displaying an image on a projection face, which may be particularly a display of the type described above.

Different technical systems have been developed for displaying images for one or more viewers. Systems of this type are projection systems such as slide projectors in which a transparent slide is irradiated by visible light and is imaged on a projection face by means of an optical system. In modern projection systems such as beamers, a (computer) image electronically generated on a display is similarly projected on a passive projection face via an optical system. However, these projection systems have the drawback that the brightness of the image is determined by the power output of the projection lamp and decreases, at a predetermined output, in accordance with the size of the projected image. Even with modern UHP lamps, a satisfactory operation of such systems in daylight surroundings is not possible.

U.S. Pat. No. 6,163,348 discloses a projection system in which the image is projected on the rear side of a specially formed, multilayer projection face. The locally different intensity of the light rays causes changes of the light transmissivity of a liquid crystal layer arranged on the front side of the projection face. Ambient light incident on the front side is therefore reflected back in different intensities by a reflection layer located behind the liquid crystal layer. The image projected on the rear side is thus transmitted onto the viewed front side of the projection face. By using color filter layers, such a projection face may also be adapted for colored image displays. Since the ambient light serves as the light source, the brightness of the image does not depend on the size of the display face but it is necessarily always smaller than the ambient brightness.

Furthermore, active displays such as, for example, computer monitors or television screens are known which radiate active light. It is true that they have a proportionally high brightness but it is very costly to manufacture large-sized, particularly planar, image formats. Particularly the number of allowed flawless pixels per TFT display requires great effort. Their number increases more than proportionally with the size of the display so that large displays are usually composed of a plurality of small ones. The individual displays are combined by means of corresponding electronics so as to generate the overall image.

Based on this background, it is an object of the present invention to provide means which also allow large image formats to be displayed with a satisfactory brightness, at low cost.

This object is achieved by an active display as defined in claim 1, a projection device as defined in claim 7 and a method as defined in claim 8. Advantageous embodiments are defined in the dependent claims.

The active display according to the invention has a display face with active pixels, in which a radiation-sensitive control unit is locally assigned to each pixel and is adapted to control the light radiation of the pixel in accordance with a signal beam received by the control unit. An “active pixel” is herein understood to mean a locally limited unit which, when driven appropriately, can generate and radiate (visible) light itself. A pixel may be particularly a structure which is constructively bounded and is defined by given components such as, for example, LEDs. However, within the scope of the invention, a pixel may also be only an (arbitrarily) geometrically bounded area of a display face built up continuously and without constructive boundaries. Furthermore, the “local assignment” between a pixel and an associated control unit means that both are arranged in a spatial relationship, usually adjoining or even overlapping each other, on the display face. The control unit may particularly control the relative brightness and/or the color with which the pixel radiates light.

The active display described above has the advantage that it can generate substantially any desired brightness on the basis of the active light generation of the pixels and is consequently independent of ambient brightness. In contrast to the known active displays such as, for example, thin-film transistor (TFT) displays, the construction is, however, significantly simpler and thus less expensive and more robust because the pixels are not electronically controlled from a central point. The control of each pixel is rather self-sufficient by means of the control unit assigned to this pixel, while the required information for the control unit is transmitted by a signal beam of electromagnetic radiation. There are various possibilities for the concrete implementation of this transmission technique, some of which will hereinafter be elucidated with reference to variants of the invention. Particularly, the transmission can in principle be realized similarly as with a conventional projection of an image on the display face, so that the techniques known for this purpose can be used. In contrast to these techniques, the brightness of the displayed image is not predetermined and limited by the projection light but this light only serves for signal transmission and may therefore be proportionally weak.

The signal beam can control the control units in an analog mode in that, for example, the intensity and color of the signal beam directly correspond to the brightness and color of a pixel to be displayed. Alternatively, the signal beam may comprise digitally encoded information. In this case, the control units comprise a decoder for extracting the digital information from the signal beam, while the control units are further adapted to control the pixel assigned to them in accordance with the decoded information. The digital transmission of information is particularly useful when the signal beam consists of visible light, because, on the one hand, the digital signal transmission is not disturbed by the ambient light or the light radiated from the pixels in this case and, on the other hand, the image to be viewed is not superposed in a disturbing manner by the visible signal radiation.

In accordance with a preferred embodiment of the active display, its control units comprise a plurality of radiation sensors having mutually different spectral sensitivities, and the control units are adapted to receive, by virtue of the radiation sensors, mutually independent parts of the signal beams. In this way, information in the signal beam can be transmitted in parallel in different spectral ranges. Particularly, three different radiation sensors having different spectral sensitivities may be provided per control unit, with each radiation sensor controlling the radiation of one of the primary colors (for example, red, green and blue) by the pixel. The sensitivity spectrum of each radiation sensor may then correspond to the controlled color (i.e. the sensor sensitive to blue light controls the blue radiation, etc.), but this may not necessarily be the case. Particularly, the spectral sensitivity of the radiation sensors may also be outside the visible range, for example, in the infrared or ultraviolet range.

The pixels of the active display preferably comprise at least one (inorganic or organic) light-emitting diode which can emit visible light. For colored display, three light-emitting diodes in the primary colors (for example, red, green, blue) are preferably provided.

For their active light radiation, the pixels require the supply of energy. This is preferably electrical energy which is provided by electric power supply lines extending in the display face and to which the pixels are connected. Furthermore, the control units may also be connected to these electric supply lines for the purpose of current supply to their electronics.

In accordance with a further embodiment of the active display, it has plug-in connections for combining it with other, similar displays. Such displays may then be plugged in and connected to each other in a modular configuration so as to form an arbitrarily large display face. Since the images are displayed by active light radiation, the manufacture of large display faces is possible without diminishing their brightness.

To transmit signal beams to the above-described active display, devices are required which are matched to the control units of the display and which will hereinafter be referred to as “projection devices”. When the control units react, for example, to the (spectral) intensity of the incident radiation, the projection device may fundamentally be implemented in known manner as a slide projector or beamer, i.e. it can generate an optical image of the image to be displayed on the display face. Both visible light and infrared or ultraviolet light may be used as radiation.

However, when the control units are adapted in such a way that they require digital information encoded in the signal beam, conventional projection devices cannot be used. The invention therefore also relates to a projection device, suitable in this case, for transmitting an image on a projection face which may be particularly a display of the type described above. The projection device comprises an optical system for deflecting beams onto the projection face and is adapted to digitally encode the image information to be displayed at one point of the projection face into a beam deflected to this point. Particularly, values of overall brightness, the brightness of a color component and/or the color composition of the pixel to be displayed may be encoded. The digital information carrier is preferably the intensity (alternating between at least two values) of the signal beam. Likewise, however, the spectral composition of the signal beam may also carry digital information.

The scope of the invention also comprises complete projection systems having an active display of the type described above, as well as a projection device adapted thereto. The projection device may be particularly a digitally encoding device of the type described hereinbefore.

The invention further relates to a method of displaying an image on a projection face which may be particularly a display of the type described above, and in which method the following steps are performed for each pixel of the image:
the information defining the pixel such as, for example, its relative brightness and its color composition, is encoded in a signal beam. In the simplest case, for example, the intensity and color composition of the signal beam may correspond in an analog manner to the desired intensity and color composition of the pixel;

the above-mentioned signal beam is deflected to an associated point on the display face. “Associated” is that point on the display face which, in the desired geometrical display of the image to be displayed on the display face, corresponds to the pixel;

a unit consisting of an active pixel and a control unit arranged at the above-mentioned point on the display face receives the signal beam directed to it and supplies light in accordance with the information encoded in the signal beam.

The described method can be particularly performed with an active display of the type described hereinbefore. It has the advantage that the brightness of the image display is independent of ambient light or of a projection lamp because of the active light radiation. However; a proportionally simple projection method of controlling the radiating pixels can be used so that image faces of quasi-arbitrary size, shape and position can be controlled without elaborate addressing techniques.

In accordance with a preferred embodiment of the method, the information defining the pixel is impressed on the signal beam in a digitally encoded form. The physical carrier of information may be particularly the intensity of the signal beam in which, for example, in the case of binary coding, a lower level of the intensity may represent a logic zero and a higher level of the intensity may represent a logic one. The spectral composition (i.e. the color) and/or the polarization of the signal beam may alternate between two or more different and distinguishable states representing logic values. These and other methods of transmitting digital information by means of signal beams are fundamentally known from digital and optical communication techniques. The traditional components and techniques can therefore be used advantageously.

Basically, the signal beam may consist of any kind of electromagnetic radiation allowing the desired transmission of information to a point on the display face. Particularly, the signal beam may consist of invisible light such as, for example, infrared light or ultraviolet light, because this light can be controlled by conventional optical systems and because it does not have a disturbing interaction with the radiation of visible light by the pixels.

These and other aspects of the invention are apparent from and will be elucidated with reference to the embodiments described hereinafter.

In the drawings:

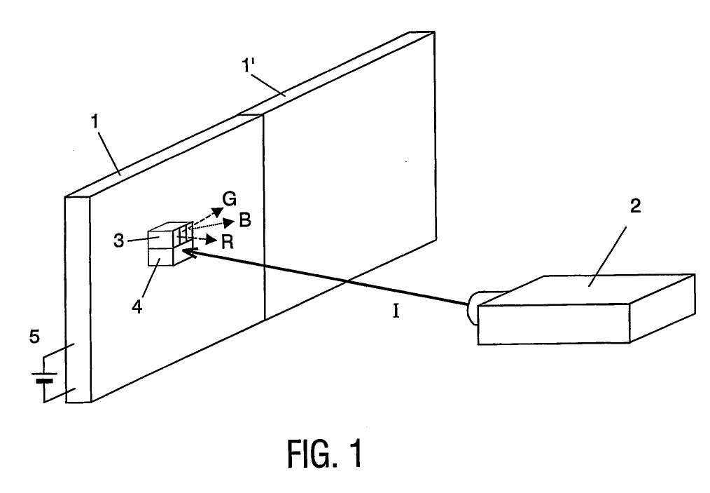

FIG. 1 shows a projection system comprising a display according to the invention;

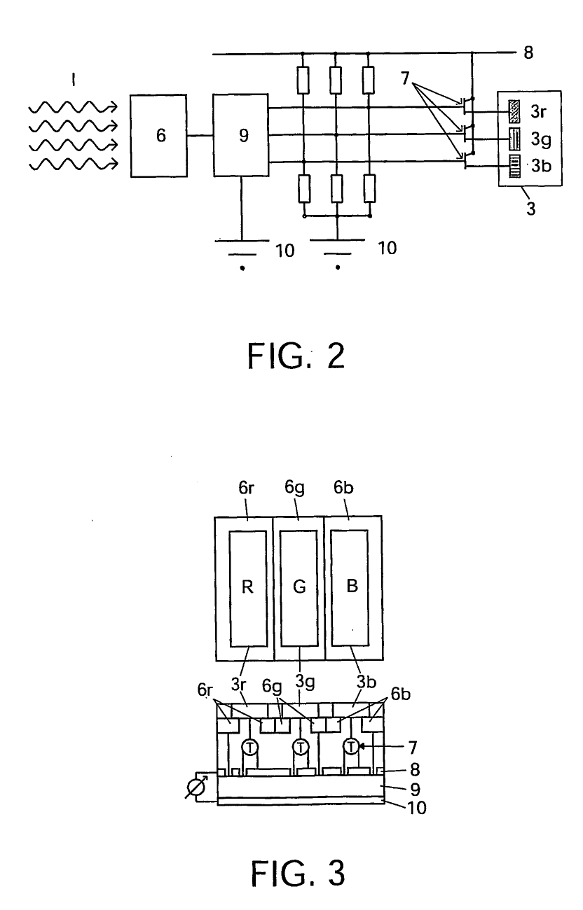

FIG. 2 is a circuit diagram for a pixel of the display in FIG. 1;

FIG. 3 shows diagrammatically the structure of the pixel in FIG. 2 in a plan view (upper part) and a side elevation (lower part).

FIG. 1 shows diagrammatically (not to scale) an active display 1 according to the invention, in a plane rectangular shape. The display face of this display 1 is constituted by the front side which is visible in the Figure. Within this display face, a representative pixel unit consisting of a control unit 4 and a three-part active pixel 3 coupled thereto is indicated in a strongly exaggerated form. Fundamentally, the overall face of the display 1 is covered without gaps with such pixel units which are preferably arranged in a regular pattern, for example, a rectangular or hexagonal pattern. A possible circuit of the pixel and its concrete structure are shown in FIGS. 2 and 3.

The display 1 is connected to a power supply 5, in which conductor tracks 8 and 10 (see FIGS. 2, 3) distribute the voltage to the pixels 3 and control units 4.

The control units 4 of the pixels are adapted to receive a signal beam I of electromagnetic radiation directed thereto, to decode information in this beam and to control the supply of light by the active pixel 3 in accordance with the decoded information. In the example shown, the pixel 3 is built up of three sub-pixels (3r, 3g, 3b in FIGS. 2 and 3), which can radiate light in the primary colors red, green and blue. In accordance with the known fundamental principles of color mixing, colors which are quasi-arbitrary for a viewer can thus be displayed on the display 1.

The signal beam I is generated by a projector 2 which is spaced apart from the display 1 and is operated separately. The projector 2 may be, for example, a slide projector or a beamer of known type and focus an optical image on the display face of the display 1, while the control units 4 evaluate the local intensity and color of the beams I incident thereon. In the simplest case, an analog control may be performed, in accordance with which the pixels 3 light up with an intensity and color which is proportional to the beam I. The display 1 then actively amplifies the image projected on the display face so that its luminous power can be adjusted independently of the ambient brightness and the capacity of the projector 2. However, it should be noted that the visible light I emitted by the projector 2 is superimposed on the ambient brightness and on the light radiated by the pixels 3. For an undisturbed operation of the image display, a corresponding time management of the projected image and the actively amplified image display is necessary.

The above-mentioned problems are obviated when the projector 2 operates in the invisible range of the spectrum, for example, in the infrared (IR) or ultraviolet (UV) range. When the signal is transmitted with infrared light, wavelengths which are within the absorption bands of sunlight are suitable for this purpose, i.e. particularly within the absorption bands of CO₂ and H₂O molecules (about 0.8 μm, 1.4 μm, etc.). Operations in these spectral ranges have the advantage that there is a minimum background radiation due to daylight, which might disturb the signal transmission. This provides the possibility of transmitting the signal in an analog mode.

A signal transmission which is robust against disturbances by daylight can also be achieved with visible light when the information to be transmitted is digitally encoded by a projector 2 adapted for this purpose. Such a projector preferably scans the display face in a line pattern and varies the intensity and/or the color of the signal beam I in accordance with the respective irradiated position. Projectors allowing scanning of a face with a (laser) beam of pixel-controlled intensity are known from, for example, U.S. Pat. No. 6,163,348.

FIG. 2 is a circuit diagram for a typical pixel, comprising a radiation-sensitive sensor unit 6 and a decoding unit 9 coupled thereto. The decoding unit 9 is connected at the output to the bases of three control transistors 7 which control the voltage supplied to three sub-pixels 3r, 3g and 3b. The sub-pixels 3r, 3g, 3b consist of, for example, semiconductor light-emitting diodes (LED) or organic light-emitting diodes (OLED) and may emit light of the color red, green, or blue. They jointly constitute the active pixel denoted by reference numeral 3 in FIG. 1. The sensor 6, the decoding unit 9 and the control transistors 7 jointly constitute the control unit 4 in FIG. 1.

The current supply for the circuit shown in FIG. 2 is realized via a conductor track 8 at a high potential and a conductor track 10 at ground potential (also compare FIG. 3).

When operating the pixel, visible light I is absorbed by the sensor 6 and its intensity is measured. The intensity signal is applied to the decoder 9 and evaluated by this decoder so as to extract, for example, digital information comprised therein for the sub-pixels 3r, 3g and 3b. After determining this information, the decoding unit 9 can then control the light output of the red, green and blue colors at the sub-pixels 3r, 3g and 3b, respectively, via the control voltage for the control transistors 7.

FIG. 3 is a plan view (upper part) and a side elevation (lower part) of a cross-section of a possible structure for a pixel comprising three sub-pixels. These sub-pixels are located as red, green and blue light-emitting diodes 3r, 3g and 3b with a rectangular face on the upper side of the pixel. Light sensors 6r, 6g and 6b are arranged under the light-emitting diodes 3r, 3g, 3b, which sensors are to be appropriately used for the different colors red, green and blue. This “appropriate use” is particularly ensured in that the sensors 6r, 6g and 6b have different maximum values of spectral sensitivity so that they are triggered by different spectral parts of the signal beam.

The sensors 6r, 6g and 6b transmit their measuring signal to the decoding logic 9 which is arranged at the lower side of the pixel between the conductor tracks 8 and 10 (ground) provided for the purpose of current supply. The three outputs of the decoding logic 9 are combined with one of the control transistors 7 whose outputs in turn control the light-emitting diodes 3r, 3g and 3b.

As already noted above, the information comprised in the signal beam I may be digitally encoded. Such an encoding may be formed, for example, through 3 bytes comprising the voltage states for the individual sub-pixels 3r, 3g, 3b in 256 color stages each (0-255). To ensure a satisfactory image quality, such control bytes should be transmitted at about 100 Hz. When digitally encoding the signal, a single sensor 6 per pixel is sufficient for all sub-pixels 3r, 3g, 3b, as is indicated in FIG. 2. For example, a photodiode, which should preferably be compatible with standard semiconductor processes, may be suitable for this purpose. Accordingly, the decoder 9 should be realized as a semiconductor circuit in which the control transistors 7 could also be integrated.

In an alternative analog encoding of the information comprised in signal beam I, each individual sub-pixel 3r, 3g, 3b is preferably controlled by a separate radiation-sensitive sensor 6r, 6g, 6b, respectively, as is shown in FIG. 3. In the case of a simple amplification of a projected visible image, the sensors 6r, 6g, 6b are sensitive to the corresponding spectral ranges red, green and blue.

However, if, as already mentioned above, an analog encoded transmission is realized by IR radiation of given spectral bands, the sub-pixels 3r, 3g, 3b are preferably controlled by a phototransistor (not shown). In the circuit diagram of FIG. 2, the sensor 6, the decoder 9 and the control transistor 7 would then be reduced to one component. In a phototransistor, the collector-base path is a photodiode. Particularly photodiodes of silicon (wavelength range 0.6-1 μm) or germanium (wavelength range 0.5-1.7 μm) are suitable for this purpose. To be able to distinguish signals for the individual sub-pixels, the semiconductors should have a different spectral sensitivity by way of a different doping. The maximum values of sensitivity of the sensors should be adjusted at, for example, 1.3 μm for the blue sub-pixel 3b, at 1.4 μm for the green sub-pixel 3g and at 1.5 μm for the red sub-pixel. Alternatively, a frequency-selective coating of the sub-pixels 3r, 3g, 3b would also be feasible.

Since the individual pixels 3, 4 of a display 1 are independent of each other, arbitrarily large projection faces can be built up in principle without any elaborate control and addressing techniques. As is indicated in FIG. 1, the projection face may be particularly composed of single display modules 1, 1′, with neighboring modules 1, 1′ contacting each other only via a plug-in connection ensuring the current supply for all modules. The projection face can thus be varied through wide ranges in dependence upon the capacity of the projector 2 which is used and on the sensitivity of the sensors.

Numerous modifications of the projection system described above, also using the fundamental principle of the invention, are feasible. For example, unlike the way shown in FIG. 1, the projector 2 may also irradiate the rear side of the display 1, 1′, in which case the sensors 4 (additionally or alternatively) should be sensitive to radiation from this direction. Furthermore, it is feasible that the pixels can be supplied with the required operating energy in a different way than by means of conductor tracks, for example, by means of homogeneous irradiation of the overall projection face, using a radio frequency. Finally, the display 1, 1′ may not be built up from discrete pixels 3, 4 with their associated constructively bounded components, but corresponding structures may instead extend homogeneously across the display face (similarly as the multilayer displays described in U.S. Pat. No. 6,163,348).

In summary, the invention thus discloses a projection system comprising a projector 2 and active displays 1, 1′ which can be combined to comparatively large projection faces. The system allows the display of large-format images with great brightness on extremely flat or thin projection faces, using a comparably small luminous power of the projector. The modular structure of the projection face allows individual adaptation to the user's requirements. In the system, the projector operating in the range of visible light (about 400 nm to 800 nm) or in the IR or UV range of the spectrum projects images on the projection face. Each pixel on the projection face has its own sensor which controls the color and relative brightness of the pixel by means of the received light signal. The individual pixels are thus self-sufficient and must externally be fed with a current only.

1. An active display (1, 1′) having a display face with active pixels (3, 3r, 3b), in which a radiation-sensitive control unit (4) is locally assigned to each pixel and is adapted to control the light radiation of the pixel in accordance with a signal beam (I) received by the control unit.

2. A display as claimed in claim 1, characterized in that at least one control unit (4) comprises a decoder (9) for extracting digitally encoded information comprised in the received signal beam (1).

3. A display as claimed in claim 1, characterized in that at least one control unit (4) comprises radiation sensors (6r, 6g, 6b) having different spectral sensitivities and is adapted to receive mutually independent parts of the signal beam (I) by means of the radiation sensors.

4. A display as claimed in claim 1, characterized in that at least one pixel (3) comprises one or more light-emitting diodes (3r, 3g, 3b).

5. A display as claimed in claim 1, characterized in that the pixels (3, 3r, 3g, 3b) and/or the control units (4) are connected to electric power supply lines (8, 10) extending through the display face.

6. A display (1) as claimed in claim 1, characterized in that it has plug-in connections for combining it with similar displays (1′).

7. A projection device (2) for displaying an image on a projection face, particularly on a display (1, 1′) as claimed in claim 1, comprising an optical system for deflecting beams (I) to points on the projection face, the projection device being adapted to digitally encode the image information to be displayed at one point of the projection face into a beam (1) deflected to said point.

8. A method of displaying an image on a projection face, particularly on a display (1, 1′) as claimed in claim 1, wherein for each pixel of the image:
the information defining said pixel is encoded in a signal beam (1);
the signal beam (I) is deflected to an associated point on the display face;
a unit consisting of an active pixel (3) and a control unit (4) arranged at said point on the display face receives the signal beam (I) and supplies light in accordance with the information comprised in the signal beam.

9. A method as claimed in claim 8, characterized in that the signal beam (I) comprises the information defining the pixel in a digitally encoded form.

10. A method as claimed in claim 8, characterized in that the signal beam (1) consists of infrared light and/or ultraviolet light.
